(19) United States
(12) Patent Application Publication
(10) Pub. No.: US 2009/0188527 A1
(43) Pub. Date: Jul. 30, 2009

(54) Cleaning System and Method

(75) Inventor: Maya P. Jedlicka, Colleyville, TX (US)

Correspondence Address: The Caldwell Firm, LLC, P.O. Box 59655, Dallas, TX, 75229, US

(73) Assignee: Riyo Pets, LLC, Colleyville, TX (US)

(21) Appl. No.: 12/356,532

(22) Filed: Jan. 20, 2009

Related U.S. Application Data
(60) Provisional application No. 61/024,531, filed on Jan. 29, 2008.

(51) Int. Cl. A47L 13/16; B08B 7/00; B08B 3/02

(52) U.S. Cl. 134/6; 15/209.1

(57) ABSTRACT

A method for cleaning a portion of material comprises identifying a portion of material requiring cleaning. The method places a first absorbent pad on the identified portion. The first absorbent pad comprises a super-absorbent material and a liquid-resistant backing. The method places a first weight on top of the first absorbent pad. The method allows a period of time to elapse. The method removes the first weight and the first absorbent pad from the identified portion. In an additional embodiment, the method further comprises spraying neutralizer on the identified portion. The method places a second absorbent pad on the identified portion. The second absorbent pad comprises a super-absorbent material and a liquid-resistant backing. The method places a second weight on top of the second absorbent pad. The method allows a period of time to elapse. The method removes the second weight and the second absorbent pad from the identified portion. In one embodiment, the first absorbent pad and the second absorbent pad each comprise a smooth-finish meltblown pad comprising a first side and a second side; a liquid-resistant layer coupled to the smooth-finish meltblown pad and configured to define an enclosed cavity between the liquid-resistant layer and the first side of the smooth-finish meltblown pad; and an absorbent powder disposed within the enclosed cavity.

### TECHNICAL FIELD

The present invention relates generally to the field of maintenance of cloth and other textile surfaces and, more particularly, to a system and method for improved cleaning, especially of small-volume spills caused by companion animals.

### BACKGROUND OF THE INVENTION

Companion animals have long served mankind in a variety of ways. Typical companion animals include cats and dogs, both of which are prone to waste elimination in inconvenient locations, often referred to as “spills” or “accidents.” Generally, as used herein, a “spill” refers to a deposit of a liquid or solid-liquid mixture onto a surface, whether intentional or accidental, biological or otherwise. Dogs especially often deposit urine, vomit, feces, or other biological material on couches, rugs, carpets, chairs, and anywhere else the dog can access. Unless properly treated, pet waste can permanently stain cloth or other textile material. Moreover, even with some conventional cleaning methods and systems, the treated area can retain odor-causing material, which can render the treated item unsuitable for further use.

Humans also cause spills, including biological spills and spills of food and/or beverages. Certain beverages, such as red wine, for example, can also cause severe staining of textile-based surfaces. Moreover, while both animal and human spills do not typically involve very large volumes of liquid, the odors and staining issues related to such spills are often extraordinarily uncomfortable to humans.

For example, especially in the case of biological spills such as vomit and urine, cleaning up the spill and treating the affected surface are very unpleasant tasks. Current cleaning methods and systems, however, often require extended contact with the untreated surface, increasing the discomfort involved in handling the spill. Some cleaning methods and systems also use harsh chemicals that can irritate human skin, also increasing the discomfort associated with cleaning the spill.

Cleaning spills of a staining liquid, such as wine, for example, or odor-causing liquid, such as urine, for example, also often require special care to remove all traces of the spilled liquid, beyond the capacity of humans to detect. This requirement often increases the total time required to clean up and treat a spill, which not only increases the discomfort associated with the spill, but also increases the time the cleaning human must spend in cleaning up the spill.

In a commercial environment, spills can also cause safety issues. Small spills can take up a lot of time, especially in retail environments, for example, causing the store to shut down aisles, causing lost sales, lost employee productivity, and potentially increased liability.

Industrial spills sometimes require a special absorbent, particularly in the case of hazardous chemicals. To respond to small spills, industry has developed some fabric absorbent materials, sometimes called “pads,” all of which, however, suffer from significant disadvantages.

For example, current pads typically require a user to touch hazardous and/or distasteful substances directly. Current pads/products do not identify potentially hazardous substances during the clean-up process; as such the user often only finds out that the substance is hazardous after it is too late to take the most effective countermeasures. Current pads do not pick up oil and water; as such a user may have to decide which spill type to treat first, which could exacerbate the damage caused by the other spill type. Current pads generally include either loose powder or comprise cumbersome rolls of insufficiently absorbent papers.

Therefore, there is a need for a system and/or method for cleaning textile surfaces in response to a small spill, including a small, pocket-sized absorbent pad that can pick up relatively small oil, water, or unknown spills, especially animal-related spills, which overcomes or limits the disadvantages associated with prior art systems and methods.

### BRIEF SUMMARY

The following summary is provided to facilitate an understanding of some of the innovative features unique to the embodiments disclosed and is not intended to be a full description. A full appreciation of the various aspects of the embodiments can be gained by taking into consideration the entire specification, claims, drawings, and abstract as a whole.

It is, therefore, one aspect of the present invention to provide for an improved fabric cleaning method.

It is a further aspect of the present invention to provide for an improved fabric cleaning system.

It is a further aspect of the present invention to provide for an improved absorbent pad cleaning system.

It is a further aspect of the present invention to provide for an improved absorbent pad cleaning method.

The aforementioned aspects and other objectives and advantages can now be achieved as described herein. A method for cleaning a portion of material comprises identifying a portion of material requiring cleaning. The method places a first absorbent pad on the identified portion. The first absorbent pad comprises a super-absorbent material and a liquid-resistant backing. The method places a first weight on top of the first absorbent pad. The method allows a period of time to elapse. The method removes the first weight and the first absorbent pad from the identified portion. In an additional embodiment, the method further comprises spraying neutralizer on the identified portion. The method places a second absorbent pad on the identified portion. The second absorbent pad comprises a super-absorbent material and a liquid-resistant backing. The method places a second weight on top of the second absorbent pad. The method allows a period of time to elapse. The method removes the second weight and the second absorbent pad from the identified portion. In one embodiment, the first absorbent pad and the second absorbent pad each comprise a smooth-finish meltblown pad comprising a first side and a second side; a liquid-resistant layer coupled to the smooth-finish meltblown pad and configured to define an enclosed cavity between the liquid-resistant layer and the first side of the smooth-finish meltblown pad; and an absorbent powder disposed within the enclosed cavity.

In an alternate embodiment, a system comprises a weight with a handle. An absorbent pad couples to the weight. The absorbent pad comprises a super-absorbent material and a liquid-resistant backing. In one embodiment, the absorbent pad comprises a smooth-finish meltblown pad comprising a first side and a second side; a liquid-resistant layer coupled to the smooth-finish meltblown pad and configured to define an enclosed cavity between the liquid-resistant layer and the first side of the smooth-finish meltblown pad; and an absorbent powder disposed within the enclosed cavity.

The present invention also provides for an absorbent pad. A smooth-finish meltblown pad comprises a first side and a second side. A liquid-resistant layer couples to the smooth-finish meltblown pad and defines an enclosed cavity between the liquid-resistant layer and the first side of the smooth-finish meltblown pad. An absorbent powder is disposed within the enclosed cavity. In one embodiment, the absorbent pad is configured to absorb between about 8 to 12 fluid ounces of liquid. In another embodiment, a surfactant is applied to at least the second side of the smooth-finish meltblown pad.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram showing an improved cleaning system; and

FIG. 2 illustrates a high-level flow diagram depicting logical operational steps of an improved cleaning method, which can be implemented in accordance with a preferred embodiment.

### DETAILED DESCRIPTION

The particular values and configurations discussed in these non-limiting examples can be varied and are cited merely to illustrate at least one embodiment and are not intended to limit the scope of the invention.

In the following discussion, numerous specific details are set forth to provide a thorough understanding of the present invention. Those skilled in the art will appreciate that the present invention may be practiced without such specific details. In other instances, well-known elements have been illustrated in schematic or block diagram form in order not to obscure the present invention in unnecessary detail.

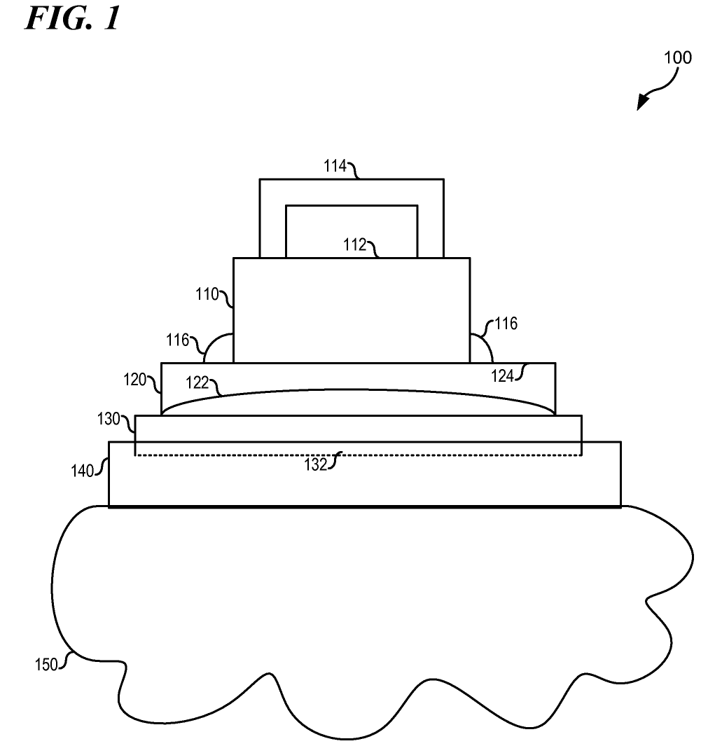

Referring now to the drawings, FIG. 1 is a high-level block diagram illustrating certain components of a system 100 for improved cleaning, in accordance with a preferred embodiment of the present invention. System 100 comprises a weight 110 and a pad 120.

Weight 110 includes bulk 112 and handle 114. Coupling devices 116 couple weight 110 to pad 120. Bulk 112 can comprise any number of well-known materials, such as, for example, plastic, plastic filled with sand, ball bearings, stainless steel, acrylic, rubber filled with sand, and/or other suitable weighted materials. Handle 114 is an otherwise conventional handle configured to improve handling and maneuverability of weight 110 by a human user. Coupling devices 116 can be any number of well-known devices configured to couple pad 120 to weight 110.

Pad 120 includes absorbent material cavity 122 and water resistant backing 124. Absorbent material cavity 122 is a super-absorbent material and can include powders disposed in a cavity formed from meltblown, as described in more detail below. Water resistant backing 124 is an otherwise conventional water resistant backing, configured to operate in conjunction with the other components of system 100, as described in more detail below.

As shown, a spill 130, comprising some liquid, is disposed onto and seeping into fabric 140, as indicated at region 132. Fabric 140 is any suitable textile or synthetic material such as, for example, carpet, rugs, cloth, or other suitable material. Substrate 150 forms a support for fabric 140 and can comprise foam, concrete, cardboard, etc., in absorbent and non-absorbent materials.

In a preferred embodiment, pad 120 is configured to pick up oil-based and water-based liquids, and a significant portion of non-liquid residue. In one embodiment, the optimum absorbency ratio is about 300-400 times the weight of the material of the pad. Accordingly, in one embodiment, 1 g of absorbent material will absorb 300-400 g of liquid. In one embodiment, pad 120 is designed for 8-12 fluid ounce spills.

In one embodiment, absorbent material cavity 122 comprises polypropylene meltblown (PPM) (“meltblown”), sprayed with a surfactant. In one embodiment, absorbent material cavity 122 includes an absorbent powder, which can be loose in the cavity or infused throughout the meltblown. In one embodiment, the powder is poly-acrylate (Na+ polyacrylate). In a preferred embodiment the powder comprises an absorption ratio in the range of 300-400:1 (in grams). In one embodiment, the powder size is in the range of +/−50 mesh (e.g., 50 mesh size granules or smaller). In one embodiment, the powder includes Kaolin clay (white powder) for improved oil/water absorption.

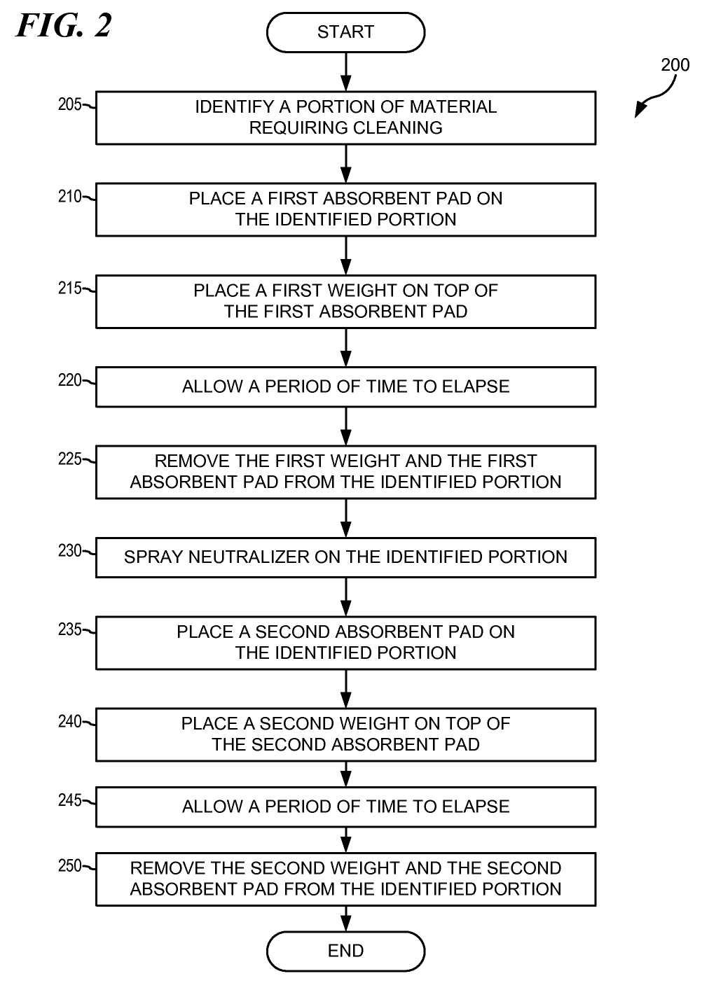

FIG. 2 illustrates one embodiment of a method for improved cleaning. Specifically, FIG. 2 illustrates a high-level flow chart 200 that depicts logical operational steps performed by, for example, system 100 of FIG. 1, which may be implemented in accordance with a preferred embodiment. Generally, a human user performs the steps of the method, unless indicated otherwise.

As indicated at block 205, the process begins, wherein the user identifies a portion of material needing cleaning. For example, a user notices that a companion animal has deposited urine on a portion of the carpet flooring, or a child has spilled carbonated soda beverage on a cloth couch. In one embodiment, the user removes large solid material before continuing the rest of the process.

Next, as illustrated at block 210, the user places a first absorbent pad, configured as described above, on the identified portion requiring cleaning. Next, as illustrated at block 215, the user places a first weight on top of the first absorbent pad. Next, as illustrated at block 220, the user allows a period of time to elapse. In a preferred embodiment, the user allows approximately 15-20 minutes to elapse.

Next, as illustrated at block 225, the user removes the first weight and the first absorbent pad. In a preferred embodiment, the user retains the weight and disposes of the first absorbent pad.

Next, as illustrated at block 230, the user sprays neutralizer on the identified portion requiring cleaning. In one embodiment, the neutralizer is an otherwise conventional neutralizer, stain remover, odor remover, and/or sterilizer. In a preferred embodiment, the neutralizer comprises a non-soapy, natural, biodegradable liquid. Generally, the neutralizer breaks down the biological substances, especially viscous substances, allowing the non-viscous liquid to be pulled out of the carpet or fabric. In some embodiments, the user allows the spray neutralizer to air dry. In a preferred embodiment, the neutralizer is a liquid treatment that neutralizes the biological substances, helping the liquid to be removed from the carpet.

Next, as illustrated at block 235, the user places a second absorbent pad, configured as described above, on the identified portion requiring cleaning. In a preferred embodiment, the second absorbent pad is not the same absorbent pad as the first absorbent pad. Next, as illustrated at block 240, the user places a second weight on top of the first absorbent pad. In a preferred embodiment, the second weight is the same weight as the first weight. Next, as illustrated at block 245, the user allows a period of time to elapse. In a preferred embodiment, the user allows approximately 15-20 minutes to elapse. In an alternate embodiment, the user allows to elapse as much time as is convenient for the user.

Next, as illustrated at block 250, the user removes the second weight and the second absorbent pad, and the process ends. In a preferred embodiment, the user retains the second weight and disposes of the second absorbent pad. In an alternate embodiment, the user uses only one absorbent pad, and sprays neutralizer onto the spill before placing the first absorbent pad on the spill.

Thus, generally, system 100 and method 200 allow a user to clean up a spill with a minimum of discomfort and generally provide numerous advantages over other methods and systems. Specifically, the novel embodiments described herein allow a user to clean up a spill without having to identify the chemical makeup of the spill, without having to incur a large amount (in a preferred embodiment, no contact) of skin contact with the spill liquids, with a minimum of time, and does not transfer the biological substance to a larger area while trying to blot and clean.

The embodiments disclosed herein also reduce the likelihood that animals will return to a smell at the spot. The embodiments disclosed herein do not require pushing and/or effort trying to soak up the liquid. The embodiments disclosed herein support user convenience, as the user can treat the spill with neutralizer, place the pad, and leave without the liquid returning to the carpet. Moreover, reduced contact reduces the chance of contamination or disease transfer. The embodiments disclosed herein also improve hygiene and cleanliness by minimizing dripping when transferring pads from soiled areas to disposal areas such as trash cans.

The embodiments disclosed herein are also scalable, in that, for example, large spills can be handled with multiple pads, eliminating the need to use large towels that have to be laundered or disposed of. The embodiments disclosed herein also support accessibility in that elderly people or people with reduced mobility, who cannot apply the pressure necessary to adequately clean accidents using conventional methods, can easily, effectively, and effortlessly clean up spills using the embodiments disclosed herein.

One skilled in the art will appreciate that variations of the above-disclosed and other features and functions, or alternatives thereof, may be desirably combined into many other different systems or applications. Additionally, various presently unforeseen or unanticipated alternatives, modifications, variations or improvements therein may be subsequently made by those skilled in the art, which are also intended to be encompassed by the following claims.

What is claimed is:

1. A method for cleaning a portion of material, comprising:
identifying a portion of material requiring cleaning;
placing a first absorbent pad on the identified portion;
wherein the first absorbent pad comprises a super-absorbent material and a liquid-resistant backing;
placing a first weight on top of the first absorbent pad;
allowing a period of time to elapse; and
removing the first weight and the first absorbent pad from the identified portion.

2. The method of claim 1, further comprising:
spraying neutralizer on the identified portion;
placing a second absorbent pad on the identified portion;
wherein the second absorbent pad comprises a super-absorbent material and a liquid-resistant backing;
placing a second weight on top of the second absorbent pad;
allowing a period of time to elapse; and
removing the second weight and the second absorbent pad from the identified portion.

3. The method of claim 1, wherein the first absorbent pad and the second absorbent pad each comprise:
a smooth-finish meltblown pad comprising a first side and a second side;
a liquid-resistant layer coupled to the smooth-finish meltblown pad and configured to define an enclosed cavity between the liquid-resistant layer and the first side of the smooth-finish meltblown pad; and
an absorbent powder disposed within the enclosed cavity.

4. A system, comprising:
a weight with a handle;
an absorbent pad coupled to the weight; and
wherein the absorbent pad comprises a super-absorbent material and a liquid-resistant backing.

5. The system of claim 4, wherein the absorbent pad comprises:
a smooth-finish meltblown pad comprising a first side and a second side;
a liquid-resistant layer coupled to the smooth-finish meltblown pad and configured to define an enclosed cavity between the liquid-resistant layer and the first side of the smooth-finish meltblown pad; and
an absorbent powder disposed within the enclosed cavity.
